(19) United States
(12) Patent Application Publication
(10) Pub. No.: US 2026/0310045 A1
(43) Pub. Date: Oct. 8, 2026

(54) OPTICAL ELEMENT DRIVING MECHANISM

(71) Applicant: Actutek Corporation, Taoyuan City (TW)

(72) Inventors: Ya-Hsiu WU, Taoyuan City (TW); Yi-Ho CHEN, Taoyuan City (TW); Ying-Jen WANG, Taoyuan City (TW); Sin-Jhong SONG, Taoyuan City (TW); Chia-Che WU, Taoyuan City (TW)

(21) Appl. No.: 19/636,581

(22) Filed: Apr. 1, 2026

Related U.S. Application Data
(60) Provisional application No. 63/782,234, filed on Apr. 2, 2025.

(51) Int. Cl. G03B 5/00

(52) U.S. Cl. CPC G03B 5/00; G03B 2205/0007; G03B 2205/0069

(57) ABSTRACT

An optical element driving mechanism is provided. The optical element driving mechanism includes a first movable portion, a fixed portion, and a first driving component. The first movable portion is configured to connect the optical element having an optical axis. The first movable portion is movable relative to the fixed portion. The first driving component is configured to drive the first movable portion to move relative to the fixed portion.

### CROSS REFERENCE TO RELATED APPLICATIONS

This application claims the benefit of U.S. provisional Application No. 63/782,234, filed Apr. 2, 2025, the entirety of which is incorporated by reference herein.

### TECHNICAL FIELD

This invention relates to an optical element driving mechanism, and in particular it relates to an optical element driving mechanism having multiple circuit components.

### BACKGROUND

As smart electronic devices continue to evolve toward thinner form factors and higher levels of integration, it has become an important focus in the relevant technical field to enable stable and precise motion control of optical systems within a limited space. Conventional optical element driving mechanisms typically include a movable portion and a fixed portion, and a driving component disposed between the movable portion and the fixed portion, such that the movable portion may drive the optical element to move relative to the fixed portion. In this way, functions such as auto-focusing, optical image stabilization, and image compensation can be achieved.

However, in conventional designs, the driving component is often disposed on a single movable portion. As such, movement in multiple directions typically requires multiple structural elements to move together, and this may increase the moving load and reduce actuation efficiency. In addition, in certain single-layer optical element driving mechanisms, if the movable portion lacks appropriate guiding or constraining structures during movement, it may not be possible to effectively control its direction of motion. This may result in unintended rotation or deviation and thereby affect the stability of the overall motion. Accordingly, how to reduce the moving load while maintaining structural configuration and degrees of freedom and improving the motion stability of the movable portion remains a challenge in the art.

### BRIEF SUMMARY

This invention provides an optical element driving mechanism, which includes a first movable portion, a fixed portion, and a first driving component. The first movable portion is configured to connect an optical element having an optical axis. The first movable portion is movable relative to the fixed portion. The first driving component is configured to drive the first movable portion to move relative to the fixed portion.

In some embodiments of the present disclosure, the optical element driving mechanism further includes a first circuit component and a second circuit component. The first circuit component is disposed on the fixed portion. The second circuit component is configured to electrically connect to an external circuit. The second circuit component has a plate-like structure. The second circuit component is not perpendicular to the optical axis. The thickness of the second circuit component is greater than 0.02 mm.

### BRIEF DESCRIPTION OF THE DRAWINGS

The embodiments of this disclosure is described in detail below with reference to the accompanying drawings. It should be noted that, in accordance with industry standard practice, many features are not drawn to scale and are only used for illustrative purposes. In fact, the dimensions of the components may be arbitrarily enlarged or reduced to clearly demonstrate the features of this disclosure.

FIG. 1 shows a perspective view of an optical element driving mechanism according to some embodiments of the present disclosure.

FIG. 2 shows an exploded view of the optical element driving mechanism according to some embodiments of the present disclosure.

FIG. 3A shows a partial perspective view of the optical element driving mechanism according to some embodiments of the present disclosure.

FIG. 3B shows a schematic diagram of a second circuit component according to some embodiments of the present disclosure.

FIG. 4 shows a top view of the optical element driving mechanism according to some embodiments of the present disclosure, wherein a housing is not shown for illustrative purposes.

FIG. 5 shows a perspective view of a portion of the optical element driving mechanism according to some embodiments of the present disclosure, wherein the housing is not shown for illustrative purposes.

FIG. 6 shows a schematic diagram of the electrical connection between a third circuit component and an extended module according to some embodiments of the present disclosure.

### DETAILED DESCRIPTION

Unless otherwise defined, all terms used herein, including technical and scientific terms, shall have the same meaning as commonly understood by one of ordinary skill in the art. It is understood that these terms, such as those defined in commonly used dictionaries, shall be interpreted as having a meaning consistent with the background or context of the relevant art and the present invention, and shall not be interpreted in an idealized or overly formal manner, unless otherwise specifically defined herein.

Furthermore, ordinal terms such as “first,” “second,” and the like, as used in the specification and the claims to modify elements thereof, do not by themselves imply any precedence of the claimed elements, nor do they indicate any order between elements or any sequence in a method of manufacture. Such ordinal terms are used merely to distinguish one element having a certain name from another element having the same name.

In addition, in some embodiments of the present disclosure, terms relating to coupling or connection, such as “connected,” “interconnected,” and the like, unless otherwise defined, may refer to two structures being in direct contact, or may also refer to two structures not being in direct contact, with one or more intermediate structures disposed there between. Such terms relating to coupling or connection may also encompass configurations in which both structures are movable, or in which both structures are fixed.

In the description of the present specification, references to terms such as “one embodiment,” “some embodiments,” “an example,” and the like indicate that the specific features, structures, materials, or characteristics described in connection with the embodiment or example are included in at least one embodiment or example of the present disclosure. In this specification, such terms are not necessarily directed to the same embodiment or example. Furthermore, the specific features, structures, materials, or characteristics described may be combined in any suitable manner in one or more embodiments or examples. In addition, a person having ordinary skill in the art may combine and integrate the different embodiments or examples described in this specification.

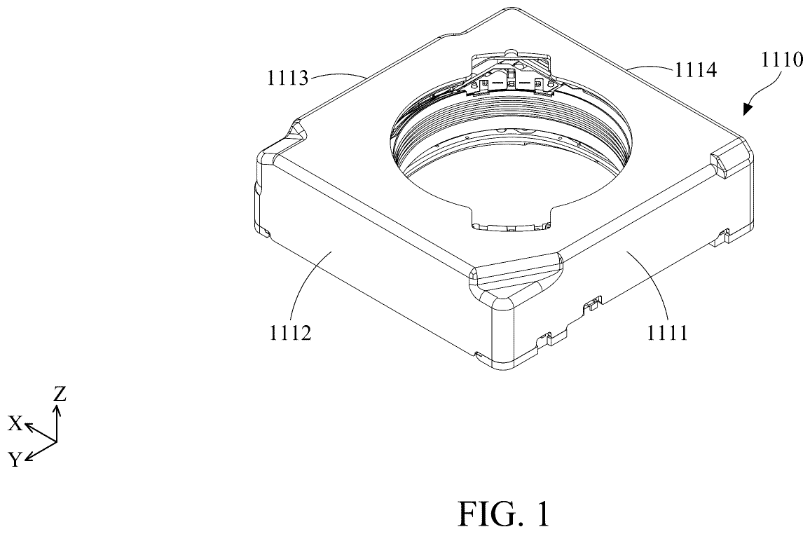

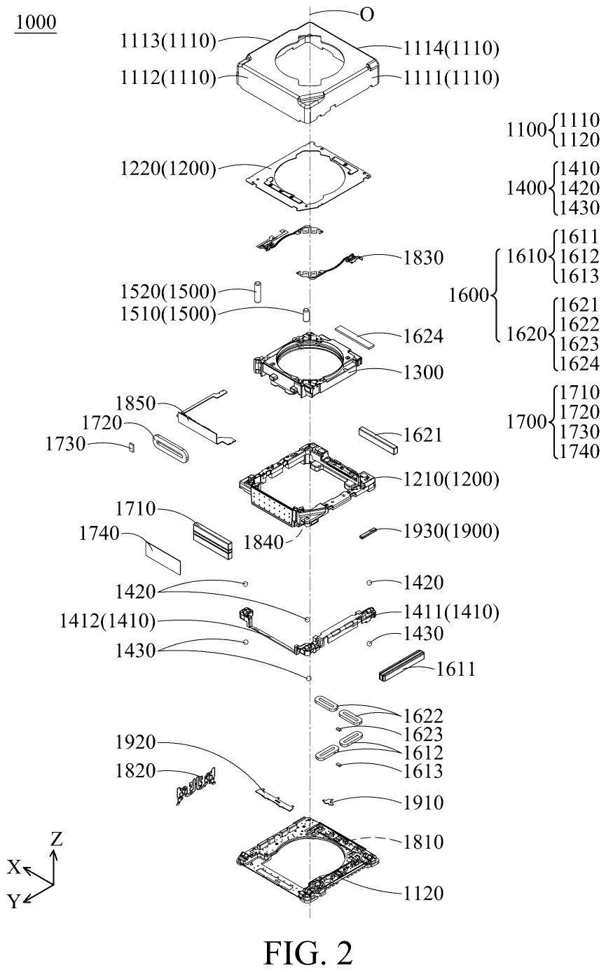

FIG. 1 shows a perspective view of an optical element driving mechanism 1000 according to some embodiments of the present disclosure. FIG. 2 shows an exploded view of the optical element driving mechanism 1000 according to some embodiments of the present disclosure. The overall structure of the optical element driving mechanism 1000 is described in detail below. Please refer to FIGS. 1 and 2.

According to some embodiments of the present disclosure, the optical element driving mechanism 1000 includes a fixed portion 1100, a first movable portion 1200, a second movable portion 1300, a first connecting component 1400, a second connecting component 1500, a first driving component 1600, a second driving component 1700, a first circuit component 1810, a second circuit component 1820, a third circuit component 1830, a fourth circuit component 1840, a fifth circuit component 1850, and a stabilizing component 1900.

According to some embodiments of the present disclosure, the fixed portion 1100 includes a housing 1110 and a bottom 1120. The housing 1110 is fixedly connected to the bottom 1120 to form an accommodating space for accommodating other components of the optical element driving mechanism 1000. As shown in FIGS. 1 and 2, when viewed along an optical axis O, the housing 1110 has a polygonal structure. The optical axis O is parallel to the Z-axis.

According to some embodiments of the present disclosure, the housing 1110 includes a first side 1111, a second side 1112, a third side 1113, and a fourth side 1114. The second side 1112 is not parallel to the first side 1111, the third side 1113 is not parallel to the second side 1112, and the third side 1113 is not parallel to the fourth side 1114. The first side 1111 is parallel to the third side 1113, and the second side 1112 is parallel to the fourth side 1114.

According to some embodiments of the present disclosure, a first movable portion 1200 is configured to connect an optical element (not shown) having an optical axis O. The first movable portion 1200 is movable relative to the fixed portion 1100. The first movable portion 1200 includes a body 1210 and a top cover 1220.

According to some embodiments of the present disclosure, the top cover 1220 of the first movable portion 1200 is fixedly disposed on the body 1210 to form a space for accommodating the second movable portion 1300. The second movable portion 1300 is configured to connect the aforementioned optical element (not shown). The second movable portion 1300 is movable relative to the first movable portion 1200.

It should be understood that, in some embodiments, the first movable portion 1200 is indirectly connected to the aforementioned optical element, while the second movable portion 1300 is directly connected to the aforementioned optical element. However, the present invention is not limited to such a configuration, and different connection arrangements may be adopted according to different requirements.

According to some embodiments of the present disclosure, the first movable portion 1200 is movable relative to the fixed portion 1100 via the first connecting component 1400. The first connecting component 1400 includes a first connecting element 1410, three first intermediate elements 1420, and three second intermediate elements 1430.

According to some embodiments of the present disclosure, the first connecting element 1410 is located between the first movable portion 1200 and the bottom 1120 of the fixed portion 1100. The first connecting element 1410 is movable relative to the fixed portion 1100, and the first movable portion 1200 is movable relative to the first connecting element 1410. A second movable portion 1300 is movable relative to the first connecting element 1410.

According to some embodiments of the present disclosure, the first connecting element 1410 includes a first base 1411 and a second base 1412. When viewed along the optical axis O, the first base 1411 is located adjacent to the first side 1111 of the housing 1110. When viewed along the optical axis O, the second base 1412 is located adjacent to the second side 1112 of the housing 1110. The extending direction of the first base 1411 is perpendicular to the extending direction of the second base 1412.

According to some embodiments of the present disclosure, the first intermediate element 1420 and the second intermediate element 1430 may be a plurality of balls. The first intermediate element 1420 is located between the first movable portion 1200 and the first connecting element 1410. The second intermediate element 1430 is located between the bottom 1120 of the fixed portion 1100 and the first connecting element 1410.

According to some embodiments of the present disclosure, the second connecting component 1500 may be a pair of guide rods having different lengths. The second movable portion 1300 is movable relative to the fixed portion 1100 via the second connecting component 1500. The second connecting component 1500 includes a second connecting element 1510 and a third connecting element 1520.

According to some embodiments of the present disclosure, the second connecting element 1510 and the third connecting element 1520 have elongated structures and extend along the optical axis O. The maximum dimension of the second connecting element 1510 along the optical axis O is different than the maximum dimension of the third connecting element 1520 along the optical axis O.

In this way, by providing the second connecting element 1510 and the third connecting element 1520 with different lengths, and disposing the shorter connecting element above the first connecting element 1410 to avoid interference with the first connecting element 1410, interference can be prevented while ensuring proper operation of the guiding structure, thereby achieving a more compact overall structural configuration and improving stability during movement.

According to some embodiments of the present disclosure, when viewed along the optical axis O, the second connecting element 1510 and the third connecting element 1520 are located adjacent to the second side 1112 of the housing 1110, and the second connecting element 1510 is closer to the first side than the third connecting element 1520. The maximum dimension of the second connecting element 1510 along the optical axis O is smaller than the maximum dimension of the third connecting element 1520 along the optical axis O.

According to some embodiments of the present disclosure, the first driving component 1600 is configured to drive the first movable portion 1200 to move relative to the fixed portion 1100. The first driving component 1600 includes a first driving portion 1610 and a second driving portion 1620. The first driving portion 1610 drives the first connecting element 1410 to move in the X-axis direction, thereby causing the first connecting element 1410 to move the first movable portion 1200 and the second movable portion 1300 in the X-axis direction. The second driving portion 1620 drives the first movable portion 1200 to move in the Y-axis direction, thereby causing the first movable portion 1200 to move the second movable portion 1300 in the Y-axis direction.

According to some embodiments of the present disclosure, the first driving portion 1610 includes a first magnetic element 1611, two first coils 1612, and a sensing element 1613. The first magnetic element 1611 is disposed on the first connecting element 1410. The first coils 1612 are disposed on the bottom 1120 of the fixed portion 1100.

According to some embodiments of the present disclosure, the first magnetic element 1611 corresponds to the first coil 1612. More specifically, when a driving signal (e.g., a current supplied by an external power source) is applied to the first coil 1612, an electro-magnetic force is generated between the first magnetic element 1611 and the first coil 1612, thereby driving the first connecting element 1410 to move along the X-axis, so as to drive the optical element to a desired position.

According to some embodiments of the present disclosure, the sensing element 1613 is disposed on the bottom 1120. The sensing element 1613 is configured to detect a magnetic field variation generated by the first magnetic element 1611 and convert the magnetic field variation into a corresponding electrical signal, so as to achieve closed-loop control of the optical element driving mechanism 1000.

According to some embodiments of the present disclosure, the second driving portion 1620 includes a second magnetic element 1621, two second coils 1622, a sensing element 1623, and a magnetically permeable element 1624. The second magnetic element 1621 is disposed on the first movable portion 1200. The second coils 1622 are disposed on the bottom 1120 of the fixed portion 1100.

According to some embodiments of the present disclosure, the second magnetic element 1621 corresponds to the second coil 1622. When a driving signal (e.g., a current supplied by an external power source) is applied to the second coil 1622, an electromagnetic force is generated between the second magnetic element 1621 and the second coil 1622, thereby driving the first movable portion 1200 to move along the Y-axis, so as to drive the optical element to a desired position.

According to some embodiments of the present disclosure, the sensing element 1623 is disposed on the bottom 1120. The sensing element 1623 is configured to detect a magnetic field variation generated by the second magnetic element 1621 and convert the magnetic field variation into a corresponding electrical signal, so as to achieve closed-loop control of the optical element driving mechanism 1000.

According to some embodiments of the present disclosure, the magnetically permeable element 1624 is disposed on the first movable portion 1200. The magnetically permeable element 1624 has a high magnetic permeability (e.g., iron, silicon steel, or the like) and is configured to effectively guide a path of magnetic flux, so as to concentrate the magnetic flux within a magnetic circuit formed by the coil and the magnet, thereby enhancing magnetic field strength and increasing magnetic force.

According to some embodiments of the present disclosure, the second driving component 1700 is configured to drive the second movable portion 1300 to move relative to the fixed portion 1100. The second driving component 1700 includes a third magnetic element 1710, a third coil 1720, a sensing element 1730, and a magnetically permeable element 1740. The third magnetic element 1710 is disposed on the first movable portion 1200. The third coil 1720 is disposed on the second movable portion 1300.

According to some embodiments of the present disclosure, the third magnetic element 1710 corresponds to the third coil 1720. More specifically, when a driving signal (e.g., a current supplied by an external power source) is applied to the third coil 1720, an electromagnetic force is generated between the third magnetic element 1710 and the third coil 1720, thereby driving the second movable portion 1300 to move along the optical axis O, so as to drive the optical element to a desired position.

According to some embodiments of the present disclosure, the sensing element 1730 is disposed on the second movable portion 1300. The sensing element 1730 is configured to detect a magnetic field variation generated by the third magnetic element 1710 and convert the magnetic field variation into a corresponding electrical signal, so as to achieve closed-loop control of the optical element driving mechanism 1000.

According to some embodiments of the present disclosure, the magnetically permeable element 1740 is disposed on the first movable portion 1200. The magnetically permeable element 1740 has a high magnetic permeability (e.g., iron, silicon steel, or the like) and is configured to effectively guide a path of magnetic flux, so as to concentrate the magnetic flux within a magnetic circuit formed by the coil and the magnet, thereby enhancing magnetic field strength and increasing magnetic force.

According to some embodiments of the present disclosure, the first circuit component 1810 is disposed on the bottom 1120 of the fixed portion 1100 and configured to connect an external circuit. More specifically, the first circuit component 1810 is metal terminals at least partially embedded within the bottom 1120. The first coil 1612, the second coil 1622, and the sensing elements 1613 and 1623 disposed on the bottom 1120 are all electrically connected to the first circuit component 1810.

According to some embodiments of the present disclosure, the second circuit component 1820 may be an upright spring member having a plate-like structure. The second circuit component 1820 is configured to be electrically connected to an external circuit. The second circuit component 1820 is not perpendicular to the optical axis O. The second circuit component 1820 has a thickness that is greater than 0.02 mm. When viewed along the optical axis O, the second circuit component 1820 is located at the third side 1113 of the fixed portion 1100 having a polygonal structure.

According to some embodiments of the present disclosure, the third circuit component 1830 is electrically connected to the second circuit component 1820. The third circuit component 1830 has a plate-like structure. The third circuit component 1830 is not parallel to the second circuit component 1820. The third circuit component 1830 is not parallel to the optical axis O.

According to some embodiments of the present disclosure, the fourth circuit component 1840 is disposed in the first movable portion 1200, and the fourth circuit component 1840 is at least partially embedded and not exposed in the first movable portion 1200. In other words, the fourth circuit component 1840 is metal terminals at least partially embedded within the body 1210 of the first movable portion 1200. The fourth circuit component 1840 is electrically connected to the third circuit component 1830.

According to some embodiments of the present disclosure, the fifth circuit component 1850 may be a flexible printed circuit board. The fifth circuit component 1850 is disposed on the second movable portion 1300. The third coil 1720 and the third sensing element 1730 are electrically connected to the fifth circuit component 1850.

According to some embodiments of the present disclosure, the stabilizing component 1900 is configured to generate a stabilizing force to urge the first movable portion 1200 toward the bottom 1120 of the fixed portion 1100. The stabilizing component 1900 includes a first stabilizing element, a second stabilizing element 1910, a third stabilizing element, a fourth stabilizing element 1920, and a fifth stabilizing element 1930.

According to some embodiments of the present disclosure, the first magnetic element 1611 of the first driving component 1600 may serve as the first stabilizing element of the stabilizing component, and the first stabilizing element is fixedly disposed on the first base 1411 of the first connecting element 1410. The third magnetic element 1710 of the second driving component 1700 may serve as the third stabilizing element of the stabilizing component, and the third stabilizing element is fixedly disposed on the body 1210 of the first movable portion 1200.

According to some embodiments of the present disclosure, the second stabilizing element 1910 is fixedly disposed on the bottom 1120 of the fixed portion 1100. Specifically, the second stabilizing element 1910 is at least partially embedded within the bottom 1120. The second stabilizing element 1910 generates a first stabilizing force with the first stabilizing element (i.e., the first magnetic element 1611 of the first driving component 1600).

According to some embodiments of the present disclosure, a fourth stabilizing element 1920 is fixedly disposed in the bottom 1120 of the fixed portion 1100. Specifically, the fourth stabilizing element 1920 is at least partially embedded in the bottom 1120. The fourth stabilizing element 1920 and the third stabilizing element (i.e., the third magnetic element 1710 of the second driving component 1700) generate a second stabilizing force.

According to some embodiments of the present disclosure, when viewed along the optical axis O, the first stabilizing element (i.e., the first magnetic element 1611) is located on the first side 1111 of the fixed portion 1100. When viewed along the optical axis O, the third stabilizing element (i.e., the third magnetic element 1710) is located on the second side 1112 of the fixed portion 1100. In this embodiment, both the first and third stabilizing elements are magnets.

As shown in FIG. 2, the fifth stabilizing element 1930 is fixedly disposed in the first movable portion 1200. The fifth stabilizing element 1930 is configured to generate a third stabilizing force. When viewed along the optical axis O, the fifth stabilizing element 1930 is located on the first side 1111 of the fixed portion 1100. The fifth stabilizing element 1930 and the first stabilizing element (i.e., the first magnetic element 1611) generate the third stabilizing force.

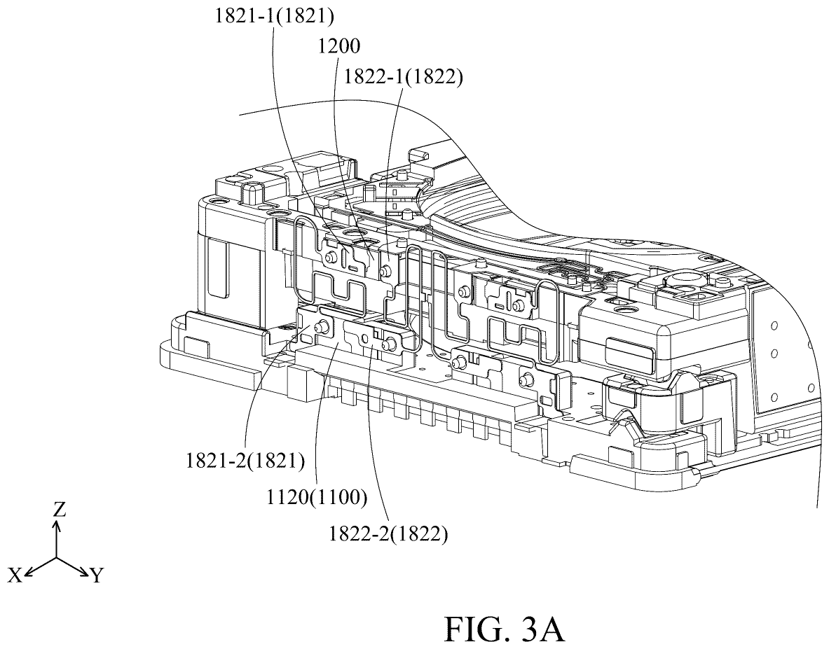

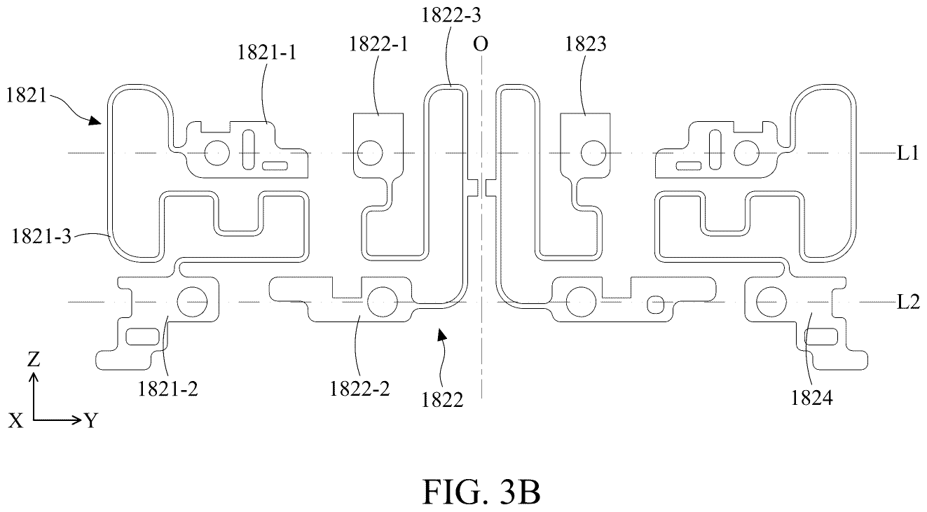

FIG. 3A shows a partial perspective view of the optical element driving mechanism 1000 according to some embodiments of the present disclosure. FIG. 3B shows a schematic diagram of the second circuit component 1820 according to some embodiments of the present disclosure. The following description is made with reference to FIGS. 3A and 3B.

According to some embodiments of the present disclosure, the second circuit component 1820 includes a first spring 1821, a second spring 1822, a third spring 1823, and a fourth spring 1824. The second spring 1822 has a different structure from the first spring 1821. The second spring 1822 is located between the first spring 1821 and the third spring 1823. The third spring 1823 is located between the second spring 1822 and the fourth spring 1824.

According to some embodiments of the present disclosure, the structure of the second spring 1822 is symmetrical to the structure of the third spring 1823. The structure of the first spring 1821 is symmetrical to the structure of the fourth spring 1824. When viewed along a first axis perpendicular to the optical axis O (this first axis is parallel to the X-axis), the second spring 1822 is closer to the optical axis O than the first spring 1821.

According to some embodiments of the present disclosure, the first axis (which is parallel to the X-axis) is perpendicular to the second circuit component 1820. When viewed along a direction perpendicular to the first axis (e.g., along the optical axis O), the third spring 1823 is closer to the optical axis O than the fourth spring 1824. When viewed along the optical axis O, the first spring 1821, the second spring 1822, and the third spring 1823 are all located on the third side 1113 (FIG. 2) of the housing 1110 of the fixed portion 1100.

As shown in FIGS. 3A and 3B, the first spring 1821 includes a first connecting end 1821-1, a first fixed end 1821-2, and a first elastic portion 1821-3. The first connecting end 1821-1 is at least partially fixedly connected to the first movable portion 1200. The first fixed end 1821-2 is at least partially fixedly connected to the bottom 1120 of the fixed portion 1100. The first connecting end 1821-1 is elastically connected to the first fixed end 1821-2 via the first elastic portion 1821-3.

According to some embodiments of the present disclosure, the second spring 1822 includes a second connecting end 1822-1, a second fixed end 1822-2, and a second elastic portion 1822-3. The second connecting end 1822-1 is at least partially fixedly connected to the first movable portion 1200. The second fixed end 1822-2 is at least partially fixedly connected to the bottom 1120 of the fixed portion 1100. The second connecting end 1822-1 is elastically connected to the second fixed end 1822-2 via the second elastic portion 1822-3.

As shown in FIG. 3B, when viewed along the first axis (which is parallel to the X-axis), a first imaginary line L1 passes through the first connecting end 1821-1 and the second connecting end 1822-1, and a second imaginary line L2 passes through the first fixed end 1821-2 and the second fixed end 1822-2. The first imaginary line L1 and the second imaginary line L2 are parallel to each other. When viewed along the first axis, the center of the first movable portion 1200 (FIG. 2) is located between the first imaginary line L1 and the second imaginary line L2.

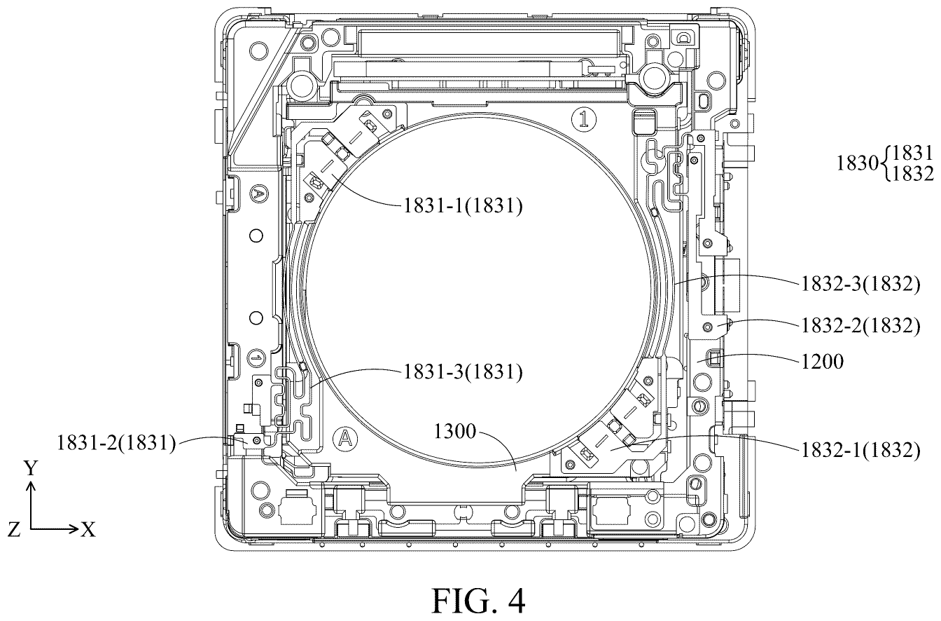

FIG. 4 shows a top view of the optical element drive mechanism 1000 according to some embodiments of the present disclosure, wherein the housing 1110 is not shown for illustrative purposes. As shown in FIG. 4, the third circuit component 1830 includes a fifth spring 1831 and a sixth spring 1832. The fifth spring 1831 is electrically connected to the first spring 1821 (FIG. 3A) via the fourth circuit component 1840 (FIG. 2).

According to some embodiments of the present disclosure, the fifth spring 1831 includes a fifth connecting end 1831-1, a fifth fixed end 1831-2, and a fifth elastic portion 1831-3. The fifth connecting end 1831-1 is at least partially fixedly connected to the second movable portion 1300. The fifth fixed end 1831-2 is at least partially fixedly connected to the first movable portion 1200. The fifth connecting end 1831-1 is elastically connected to the fifth fixed end 1831-2 via the fifth elastic portion 1831-3.

According to some embodiments of the present disclosure, the sixth spring 1832 has a different structure from the first spring 1821 (FIG. 3B), and the sixth spring 1832 is electrically connected to the second spring 1822 (FIG. 3B). The sixth spring 1832 includes a sixth connecting end 1832-1, a sixth fixed end 1832-2, and a sixth elastic portion 1832-3.

According to some embodiments of the present disclosure, the sixth connecting end 1832-1 is at least partially fixedly connected to the second movable portion 1300. The sixth fixed end 1832-2 is at least partially fixedly connected to the first movable portion 1200. The sixth connecting end 1832-1 is elastically connected to the sixth fixed end 1832-2 via the sixth elastic portion 1832-3.

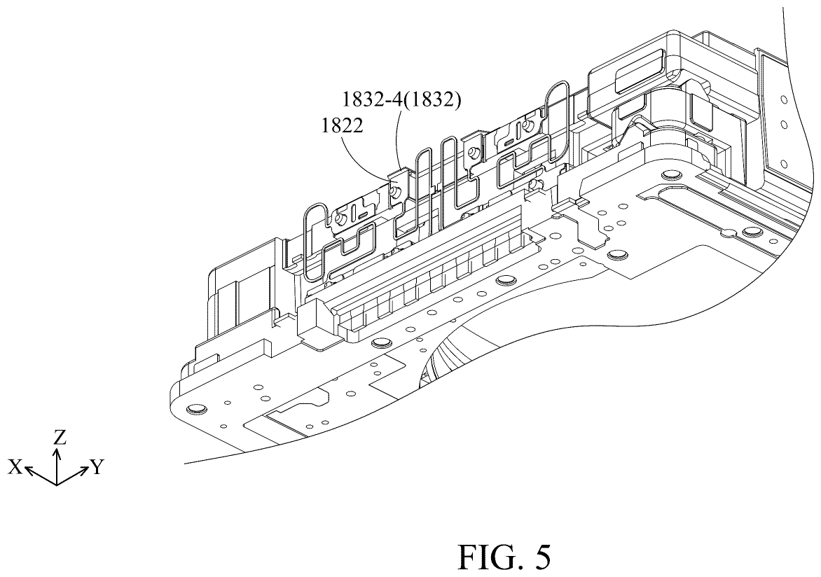

FIG. 5 shows a perspective view of a portion of the optical element drive mechanism 1000 according to some embodiments of the present disclosure, wherein the housing 1110 is not shown for illustrative purposes. As shown in FIG. 5, the sixth spring 1832 also includes a protrusion 1832-4 protruding toward the second spring 1822.

As shown in FIG. 5, when viewed along the thickness direction of the sixth spring 1832 of the third circuit component 1830, the protrusion 1832-4 at least partially does not overlap the second spring 1822. A first electrical connection point (not shown) is located at the protrusion, through which the sixth spring 1832 is electrically connected to the second spring 1822. It should be noted that the aforementioned first electrical connection point may be solder, that is, the sixth spring 1832 may be electrically connected to the second spring 1822 by soldering.

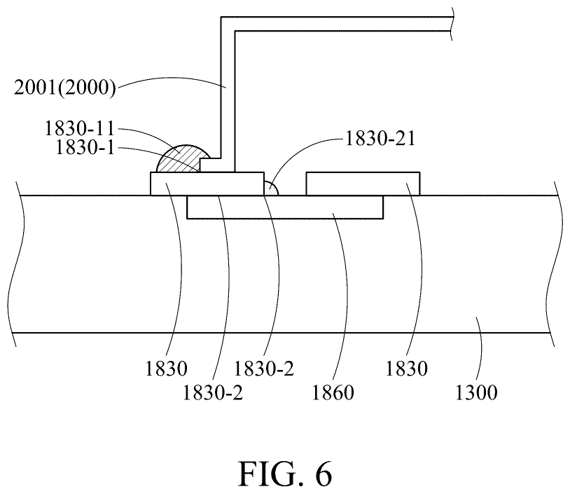

FIG. 6 illustrates a schematic diagram of an electrical connection portion 2001 between the third circuit component 1830 and an extended module 2000 according to some embodiments of the present disclosure. In some embodiments, the extended module 2000 may be an aperture module disposed on the optical element driving mechanism 1000. The third circuit component 1830 is electrically connected to the extended module 2000.

According to some embodiments of the present disclosure, the extended module 2000 is electrically connected to the third circuit component 1830 via a second electrical connection point 1830-1. The third circuit component 1830 is electrically connected to a circuit component 1860 embedded in the second movable portion 1300 via a third electrical connection point 1830-2, and the second electrical connection point 1830-1 is adjacent to the third electrical connection point 1830-2.

According to some embodiments of the present disclosure, the second electrical connection point 1830-1 includes a first electrical connection element 1830-11, and the third electrical connection point 1830-2 includes a second electrical connection element 1830-21. The first electrical connection element 1830-11 and the second electrical connection element 1830-21 are made of different materials and have different melting points.

According to some embodiments of the present disclosure, the second electrical connection element 1830-21 and the sixth spring 1832 are made of the same material. The melting point of the second electrical connection element 1830-21 is higher than that of the first electrical connection element 1830-11. The second electrical connection point 1830-1 is located at the sixth connecting end 1832-1 (FIG. 4). The third electrical connection point 1830-2 is located at the sixth connecting end 1832-1 (FIG. 4).

Accordingly, by configuring the first electrical connection element 1830-11 and the second electrical connection element 1830-21 to be formed of different materials and to have different melting points, and by setting the melting point of the second electrical connection element 1830-21 to be higher than that of the first electrical connection element 1830-11, the third circuit component 1830 and the circuit component 1860 may first be fixedly joined by a fusion bonding process using the second electrical connection element 1830-21, and thereafter the extended module 2000 is electrically connected to the third circuit component 1830 by a soldering process using the first electrical connection element 1830-11. Due to the difference in melting points, the previously formed fusion-bonded joint can be effectively maintained during the subsequent soldering process, thereby preventing loosening or de-soldering of the prior electrical connection and improving the overall reliability of the electrical connections.

According to some embodiments of the present disclosure, a protective element (not shown) directly contacts the second electrical connection point 1830-1, and the protective element also directly contacts the third electrical connection point 1830-2. The protective element is made of resin to improve the reliability of the overall electrical connection.

In summary, the present disclosure provides a configuration in which driving structures are respectively disposed on different movable portions, such that each movable portion may be driven in its corresponding direction of motion. Under certain operating conditions, the weight of components required to be driven may be reduced, thereby helping to reduce moving load and improve driving efficiency. In addition, by using a guiding structure to constrain the direction of movement of the movable portions, unintended rotation or deviation that may occur during movement can be suppressed, thereby further improving overall motion stability and reliability.

Furthermore, by configuring the first electrical connection element and the second electrical connection element to have different materials and different melting points, and by setting the melting point of the second electrical connection element to be higher than that of the first electrical connection element, the third circuit component may first form an electrical connection with the circuit component disposed in the second movable portion, and subsequently form an electrical connection with the extended module. As a result, the previously formed electrical connection can be effectively maintained during the subsequent soldering process, thereby improving the overall reliability of the electrical connections.

Although embodiments of the present invention and advantages thereof have been described above, it should be understood that any person having ordinary skill in the art may make modifications, substitutions, and alterations without departing from the spirit and scope of the present invention. In addition, the scope of protection of the present invention is not limited to the specific processes, machines, manufactures, compositions of matter, apparatuses, methods, and steps described in the specification. Any processes, machines, manufactures, compositions of matter, apparatuses, methods, or steps, whether currently existing or later developed, that perform substantially the same function or achieve substantially the same result as the corresponding embodiments described herein may be utilized according to the present invention. Accordingly, the scope of the present invention is intended to include such processes, machines, manufactures, compositions of matter, apparatuses, methods, and steps. Furthermore, each claim constitutes a separate embodiment, and the scope of the present invention also encompasses combinations of the claims and the embodiments.

What is claimed is:

1. An optical element driving mechanism, comprising:
a first movable portion, configured to connect an optical element having an optical axis;
a fixed portion, wherein the first movable portion is movable relative to the fixed portion; and
a first driving component, configured to drive the first movable portion to move relative to the fixed portion.

2. The optical element driving mechanism as claimed in claim 1, further comprising a first circuit component and a second circuit component, wherein the first circuit component is disposed on the fixed portion, the second circuit component is configured to electrically connect to an external circuit, the second circuit component has a plate-like structure, the second circuit component is not perpendicular to the optical axis, and the thickness of the second circuit component is greater than 0.02 mm.

3. The optical element driving mechanism as claimed in claim 2, wherein the second circuit component comprises:
a first spring;
a second spring having a different structure from the first spring;
a third spring, wherein the second spring is located between the first spring and the third spring; and
a fourth spring, wherein the third spring is located between the second spring and the fourth spring;
wherein a structure of the second spring is symmetrical to a structure of the third spring;
wherein a structure of the first spring is symmetrical to a structure of the fourth spring;
wherein when viewed along a first axis perpendicular to the optical axis, the second spring is closer to the optical axis than the first spring;
wherein when viewed along a direction perpendicular to the first axis, the third spring is closer to the optical axis than the fourth spring;
wherein the first axis is perpendicular to the second circuit component.

4. The optical element driving mechanism as claimed in claim 3, wherein the first spring comprises:
a first connecting end, at least partially fixedly connected to the first movable portion;
a first fixed end, at least partially fixedly connected to the fixed portion; and
a first elastic portion, wherein the first connecting end is elastically connected to the first fixed end via the first elastic portion.

5. The optical element driving mechanism as claimed in claim 4, wherein the second spring comprises:
a second connecting end, at least partially fixedly connected to the first movable portion;
a second fixed end, at least partially fixedly connected to the fixed portion; and
a second elastic portion, wherein the second connecting end is elastically connected to the second fixed end via the second elastic portion.

6. The optical element driving mechanism as claimed in claim 5, wherein when viewed along the first axis, a first imaginary line passes through the first connecting end and the second connecting end, and a second imaginary line passes through the first fixed end and the second fixed end; and the first imaginary line and the second imaginary line are parallel to each other;
wherein when viewed along the first axis, a center of the first movable portion is located between the first imaginary line and the second imaginary line.

7. The optical element driving mechanism as claimed in claim 3, further comprising:
a second movable portion configured to connect the optical element, and the second movable portion is movable relative to the first movable portion;
a second driving component configured to drive the movement of the second movable portion; and
a third circuit component electrically connected to the second circuit component;
wherein the third circuit component has a plate-like structure and is not parallel to the second circuit component, and the third circuit component is not parallel to the optical axis.

8. The optical element driving mechanism as claimed in claim 7, wherein the third circuit component comprises a fifth spring and a sixth spring, and the fifth spring comprises:
a fifth connecting end, at least partially fixedly connected to the second movable portion;
a fifth fixed end, at least partially fixedly connected to the first movable portion; and
a fifth elastic portion, wherein the fifth connecting end is elastically connected to the fifth fixed end via the fifth elastic portion.

9. The optical element driving mechanism as claimed in claim 8, wherein the sixth spring has a different structure from the first spring, and the sixth spring is electrically connected to the second spring, the sixth spring comprises:
a sixth connecting end, at least partially fixedly connected to the second movable portion;
a sixth fixed end, at least partially fixedly connected to the first movable portion; and
a sixth elastic portion, wherein the sixth connecting end is elastically connected to the sixth fixed end via the sixth elastic portion;
wherein the sixth spring further comprises a protrusion that protrudes toward the second spring.

10. The optical element driving mechanism as claimed in claim 9, wherein when viewed along a thickness direction of the third circuit component, the protrusion does not overlap the second spring at least partially;
wherein a first electrical connection point is located at the protrusion, and the sixth spring is electrically connected to the second spring via the first electrical connection point.

11. The optical element driving mechanism as claimed in claim 9, further comprising a fourth circuit component electrically connected to the third circuit component, wherein the fourth circuit component is disposed in the first movable portion, the fourth circuit component is at least partially embedded and not exposed in the first movable portion, and the fifth spring is electrically connected to the first spring via the fourth circuit component.

12. The optical element driving mechanism as claimed in claim 11, wherein the third circuit component is configured to electrically connect an extended module, the extended module is electrically connected to the third circuit component via a second electrical connection point, and the second electrical connection point is adjacent to a third electrical connection point.

13. The optical element driving mechanism as claimed in claim 12, wherein the second electrical connection point comprises a first electrical connection element, the third electrical connection point comprises a second electrical connection element, the first electrical connection element and the second electrical connection element are made of different materials, and the first electrical connection element and the second electrical connection element have different melting points.

14. The optical element driving mechanism as claimed in claim 13, wherein the second electrical connection element and the sixth spring are made of the same material, a melting point of the second electrical connection element is higher than a melting point of the first electrical connection element, the second electrical connection point is located at the sixth connecting end, and the third electrical connection point is also located at the sixth connecting end.

15. The optical element driving mechanism as claimed in claim 14, wherein a protective element is in direct contact with the second electrical connection point, the protective element is in direct contact with the third electrical connection point, and the protective element is made of resin.

16. The optical element driving mechanism as claimed in claim 9, further comprising:
a first connecting component, wherein the first movable portion is movable relative to the fixed portion via the first connecting component; a first connecting element of the first connecting component is located between the first movable portion and the fixed portion, the first connecting element is movable relative to the fixed portion; the first movable portion is movable relative to the first connecting element, and the second movable portion is movable relative to the first connecting element; and
a stabilizing component configured to generate a stabilizing force to urge the first movable portion toward the fixed portion.

17. The optical element driving mechanism as claimed in claim 16, wherein when viewed along the optical axis, the fixed portion has a polygonal structure, and the fixed portion comprises:
a first side; and
a second side, not parallel to the first side;
wherein when viewed along the optical axis, a first base of the first connecting element is located on the first side, and a second base of the first connecting element is located on the second side.

18. The optical element driving mechanism as claimed in claim 17, wherein when viewed along the optical axis, the second circuit component is located on a third side of the fixed portion having a polygonal structure, and the third side is not parallel to the second side;
wherein when viewed along the optical axis, the first spring, the second spring, and the third spring are all located on the third side.

19. The optical element driving mechanism as claimed in claim 18, wherein the stabilizing component comprises:
a first stabilizing element, fixedly disposed on the first connecting element;
a second stabilizing element, fixedly disposed on the fixed portion and generating a first stabilizing force with the first stabilizing element;
a third stabilizing element, fixedly disposed on the first movable portion; and
a fourth stabilizing element, fixedly disposed on the fixed portion and generating a second stabilizing force with the third stabilizing element.

20. The optical element driving mechanism as claimed in claim 19, wherein when viewed along the optical axis, the first stabilizing element is located on the first side;
wherein when viewed along the optical axis, the third stabilizing element is located on the second side;
wherein the stabilizing component further comprises a fifth stabilizing element, which is fixedly disposed on the first movable portion and configured to generate a third stabilizing force;
wherein when viewed along the optical axis, the fifth stabilizing element is located on the first side;
wherein the fifth stabilizing element and the first stabilizing element generate the third stabilizing force, the first stabilizing element is a magnet, and the third stabilizing element is a magnet.
